(19) United States
(12) Patent Application Publication
(10) Pub. No.: US 2019/0018406 A1
(43) Pub. Date: Jan. 17, 2019

(54) REMOTE DRIVER ASSISTANCE

(71) Applicant: ZF FRIEDRICHSHAFEN AG, Friedrichshafen (DE)

(72) Inventor: Cosmin TUDOSIE, Friedrichshafen (DE)

(21) Appl. No.: 15/750,597

(22) PCT Filed: Jul. 19, 2016
(86) PCT No.: PCT/EP2016/067107

§ 371 Date: Feb. 6, 2018

(30) Foreign Application Priority Data
Aug. 19, 2015 (DE) 10 2015 215 807.1

(51) Int. Cl. G05D 1/00; G07C 5/00

(52) U.S. Cl. CPC G05D 1/0022; G07C 5/008; G05D 2201/0213; G05D 1/0061; G05D 1/0088

(57) ABSTRACT

A control unit for a motor vehicle including a sensor for scanning an environment of the motor vehicle; a communication device for transmission of sensor data and for receiving control data via a communication channel; and a processing device for controlling the motor vehicle on the basis of the control data received.

This application is a National Stage completion of PCT/EP2016/067107 filed Jul. 19, 2016, which claims priority from German patent application serial no. 10 2015 215 807.1 filed Aug. 19, 2015.

### FIELD OF THE INVENTION

The invention concerns a monitoring system for a motor vehicle, in order to ensure the driving or operating safety of the motor vehicle.

### BACKGROUND OF THE INVENTION

Driving a motor vehicle can be challenging for a driver. In particular, inexperienced drivers or those driving under especially difficult driving conditions such as black ice or fog can occasionally be overtaxed by the control of the motor vehicle. Even a professional driver with a lot of experience may occasionally need help in driving his vehicle, for example if some piece of equipment on board the motor vehicle is not working properly.

It is known to send telemetry data from a motor vehicle to a location outside the motor vehicle in order to there subject the data to further analysis. Thereupon, a recommendation is usually generated for the driver on how to improve the control of his vehicle.

DE 10 2010 063 401 A1 concerns an access control system for providing an authorized person with access to a piece of equipment.

### SUMMARY OF THE INVENTION

The purpose of the present invention is to provide a technique for improved driver assistance. The invention achieves this objective by means of the objects of the independent claims. The subordinate claims describe preferred embodiments.

A control unit for a motor vehicle comprises at least one sensor for scanning an environment of the motor vehicle; a communication device for the transmission of sensor data and for receiving control data by way of a communication channel; and a processing device for controlling the motor vehicle on the basis of the control data received.

Advantageously the motor vehicle can for example be monitored from a remote position, in that information is analyzed, from which conclusions can be drawn about a driving condition or an environment of the motor vehicle. If necessary the remote site can even intervene directly in the control of the motor vehicle and thereby, for example, carry out a driving maneuver of which a driver of the motor vehicle is not capable. For example a driver who feels overtaxed by a driving situation can call for help from an external system or an external expert. This can increase the safety of the motor vehicle and the safety of traffic around it.

Preferably, the communication device is designed to establish the communication channel in an encoded and/or authenticated manner. This can on the one hand prevent an unauthorized location from receiving information about the environment of the motor vehicle or its driving condition. On the other hand, an unauthorized site can also be prevented from intervening in the control of the motor vehicle.

Particularly preferably the control unit also comprises an interface with another control system on board the motor vehicle, in order to check driving information of the motor vehicle. In that case, the communication device is designed to transmit the driving information as well. The driving information can for example include a speed, a direction, a position and information about the state of, for example, a drive system or a brake system on board the motor vehicle.

A method for controlling a motor vehicle comprises steps of establishing a communication channel between the motor vehicle and an external position, transmitting the driving information and/or sensor data scanned in the environment of the motor vehicle, by way of the communication channel, to the position, the reception by the motor vehicle of a request to hand over control of the motor vehicle, the reception by the motor vehicle of control information, and the controlling of the motor vehicle on the basis of the control information received.

In accordance with the method, the takeover of control of the motor vehicle by the remote site can be accepted or rejected on board the motor vehicle. This ensures that the motor vehicle is not remotely controlled against the wishes of a driver who carries responsibility for the motor vehicle.

In a further embodiment the takeover of control over the motor vehicle is initiated by transmitting a corresponding request from the motor vehicle to the remote site. This request can be transmitted along with the driving information and/or sensor data. Thus, a system or a person on board the motor vehicle can voluntarily request assistance from the remote site.

In a particularly preferred embodiment, the request for the takeover is transmitted after it has been determined that an autonomous control system of the motor vehicle has relinquished control or is at the point of doing so. In particular, if the autonomous control system detects that it cannot safely cope with an existing or forthcoming traffic situation, then for example in parallel with a takeover request to the driver of the motor vehicle it can additionally request external assistance.

In a further preferred embodiment it is additionally determined from a takeover attempt that a driver on board the motor vehicle has not assumed control over a predetermined time or has refused to assume control. One reason for this could be that the driver himself regards the situation as too much for him. Another reason could be that there is a technical fault on board the motor vehicle which does not allow the driver to drive the motor vehicle safely. On the part of the external site help can then be offered, such assistance being provided for example by a human expert or by a technical system not present on board the motor vehicle. The technical system can for example include an analysis system for fault conditions on board the motor vehicle that can be diagnosed electronically.

A computer program product comprises program code means for carrying out the above-described method when the computer program product is run on a processing device or stored on a computer-readable data carrier.

A monitoring device comprises a communication device for establishing communication channels to a plurality of motor vehicles, such that each communication channel is designed to receive sensor data and/or driving information from a motor vehicle and to transmit control data to the motor vehicle, as well as an output element for the output of sensor data and an operating element for the input of control data.

### BRIEF DESCRIPTION OF THE DRAWINGS

The invention will now be described in more detail with reference to the attached figures, which show:

FIG. 1: A schematic representation of a system comprising a motor vehicle and a site remote therefrom; and

FIG. 2: A flow chart of a method for controlling the motor vehicle of FIG. 1.

### DETAILED DESCRIPTION OF THE PREFERRED EMBODIMENTS

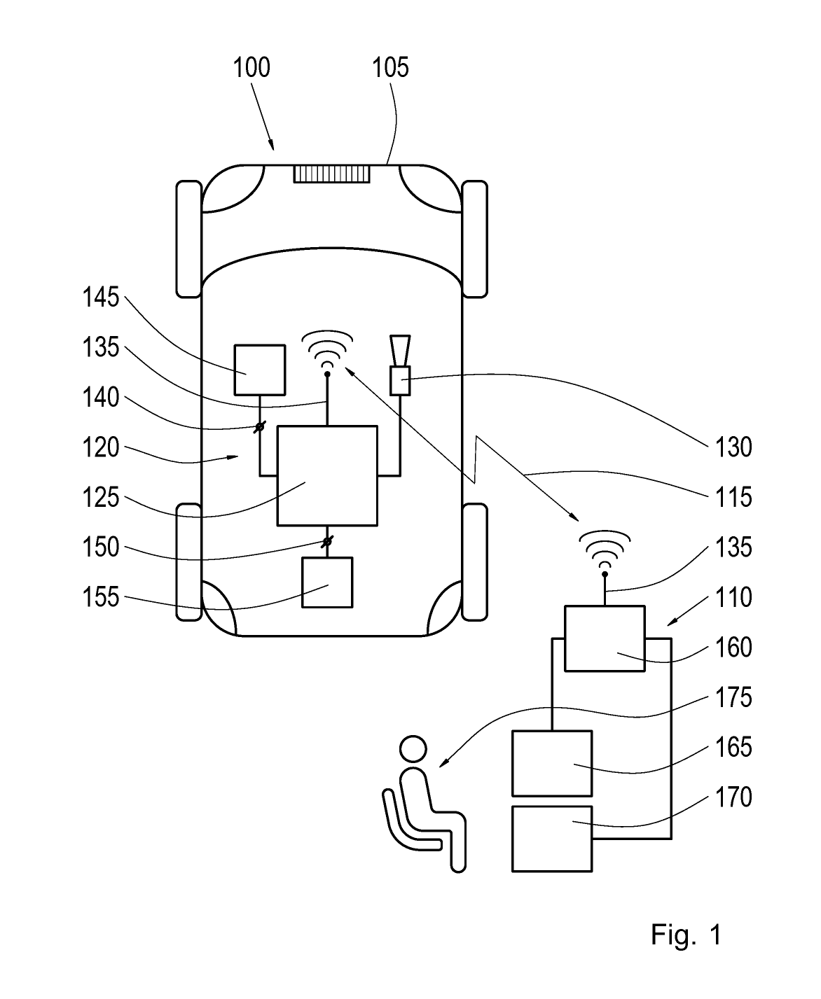

FIG. 1 shows a system 100 that includes a motor vehicle 105 and a remote site 110. Between the motor vehicle 105 and the remote site 110 there is a communication channel 115, which is preferably authenticated and/or encoded. Any known methods can be used for authentication or encoding. The authentication ensures that the respective communication partners are who they say they are. The encoding ensures that neither can information be received from the communication channel 115, nor can other information be fed into the communication channel 115 by unauthorized parties.

On board the motor vehicle 105 is arranged a control unit 120, which comprises a processing device 125, a sensor 130 and a communication device 135 as a terminal of the communication channel 115. The sensor 130 is designed to scan an environment of the motor vehicle 105. In particular, the sensor 130 can comprise a video sensor, a radar or Lidar sensor or some other sensor which provides the most sufficient possible information from the environment of the motor vehicle 105 in order to enable control of the motor vehicle 105 on the basis of the information.

Preferably the control unit 120 also comprises an interface 140 for connection to another control system 145 on board the motor vehicle 105. The control system 145 can for example comprise an engine control unit for a drive engine of the motor vehicle 105 or a navigation system for determining a position of the motor vehicle 105. The information supplied by way of the interface 140 preferably indicates a driving condition or a technical condition of the motor vehicle 105. For example, the information checked by way of the interface 140 can include a fault condition of the control system 145.

In addition, the control unit 120 comprises a further interface 150 that can be connected to a control device 155 on board the motor vehicle 105. The control device 155 is preferably designed to carry out a longitudinal or transverse control of the motor vehicle 105. Preferably the control unit 120 is designed for the autonomous control of the motor vehicle 105, that is to say, the control of the longitudinal or transverse movement can take place without the intervention and supervision of a driver. If during this an irremediable control error occurs, then an alarm is usually emitted to the driver. However, the driver must not take over control before the lapse of a predetermined takeover time, for example 15 seconds, and until the end of that takeover time control can be maintained by the control unit 120. In another embodiment the control device 155 can also be designed to control a separate or additional piece of equipment on board the motor vehicle 105, such as a winch or a hydraulic crane. If the motor vehicle 105 is a utility vehicle such as a truck, a bus, a special vehicle or even a taxi, then any desired useful function of the motor vehicle 105 can be controlled by the control device 155. Preferably, intervention in the function controlled is possible in that corresponding data are transmitted via the interface 150.

The remote site 110 is outside the motor vehicle 105 and can be either at a fixed location, or mobile. For example, in a first embodiment the remote site 110 can be a central site set up at almost any desired distance from the motor vehicle 105. In a second embodiment the remote site 110 is itself arranged on board a motor vehicle which, for example, can be in the environment of the motor vehicle 105.

The remote site 110 comprises a communication device 135 as the second terminal of the communication channel 115, and a processing device 160. Preferably, an output element 165 is provided on which information about the motor vehicle 105 can be displayed. In particular, pictorial information previously scanned by the sensor 130 on board the motor vehicle 105 can be displayed on the output element 165. Associated with the pictorial information there can be other types of information, for example numerical information, for example received previously by way of the interface 140 on board the motor vehicle 105. The processing device 160 can serve for appropriate, in particular graphical preparation of the information about the motor vehicle 105.

In addition it is preferable for the remote site 110 to have an operating element 170 which for example allows a person 175 at the remote site 110 to carry out inputs which are then processed, transmitted to the motor vehicle 105 and there interpreted as control information that can be passed on via the interface 150 to the control device 155.

Particularly in the case of a positionally fixed remote site 110, it is preferable for the communication device 135 to be designed to maintain a plurality of communication channels 115 to a plurality of motor vehicles 105. The information displayed by the output element 165 can then relate to several of the motor vehicles 105. By means of the operating element 170 the person 175 can also influence the display of information on the output element 165. For example, views can be enlarged, displaced or changed in some other way. It is preferable for the output element 165 to enable the display of information about several motor vehicles 105, so that the person 175 can monitor several motor vehicles 105 and if he suspects irregularities in one of the motor vehicles 105, can if necessary take over control thereof.

The motor vehicle 105 can for example comprise a building machine and the person 175 can for example carry out a particularly difficult process which the driver of the building machine cannot manage by himself. The person 175 can even control several motor vehicles 105 at the same time, particularly when these are interacting. For example, two cranes which are together lifting a bulky load and which have to maneuver through a narrow passage can be controlled by the same person 175. In that way preliminary planning and discussions between crane drivers can be saved. In that way the problem, a complex, three-dimensional problem to be discussed verbally between the crane drivers, can be circumvented in an elegant manner. This can boost the productivity of the motor vehicles 105 or increase operational safety.

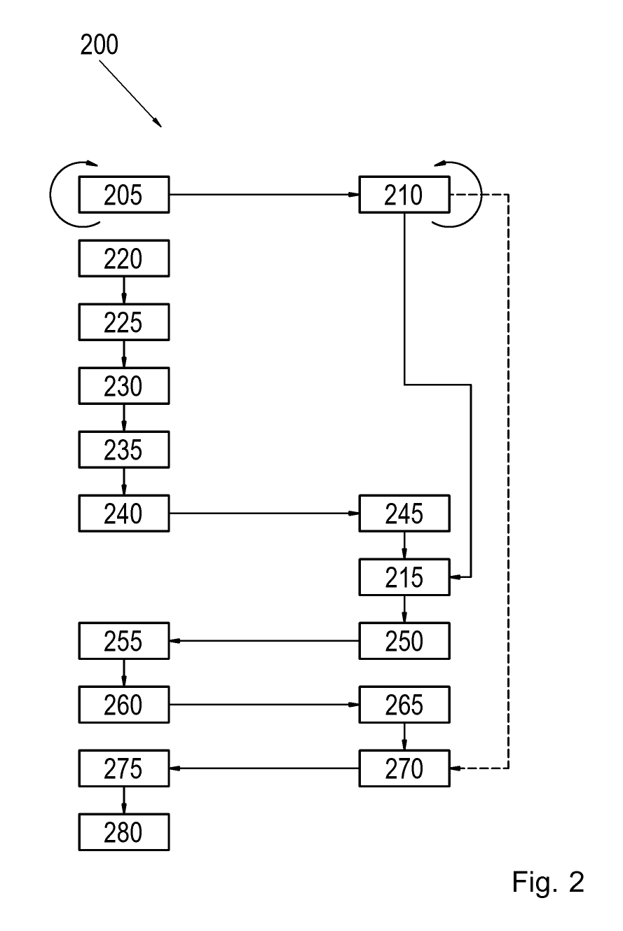

FIG. 2 shows a method 200 for controlling the motor vehicle 105 of FIG. 1. The method 200 can in particular be carried out by the processing devices 125 on the part of the motor vehicle 105 and 160 on the part of the remote site 110. The representation in FIG. 2 shows the steps associated with the motor vehicle 105 on the left and those associated with the remote site 110 on the right.

In an optional step 205 sensor data and/or driving information from the motor vehicle 105 are transmitted by way of the communication channel 115. In a subsequent step 210 these data are received at the remote site 110. These two steps preferably take place continually in an endless loop. The information received in step 210 can then be analyzed in a step 215. For this the analysis is preferably carried out by computer, that is to say, by the processing device 160 at the remote site 110. In another embodiment an analysis can also be carried out by the person 175, to whom the information is presented by means of the output element 165. In that case the person 175 can in particular be assisted by an expert who, on the basis of the information presented on the output element 165, can all the better see things from the standpoint of the driver of the motor vehicle 105. The expert can take over control of the motor vehicle 105 if the driver cannot cope with the matter in hand alone or by himself.

For example, breakdown assistance can be given if on board the motor vehicle 105 there occurs a fault or if the motor vehicle 105 has been involved in an accident. A particularly difficult task of the motor vehicle 105 can even be carried out by the person 175 when no driver at all is on board the motor vehicle 105. Hazardous jobs such as mine clearance can in this way be carried out with less risk to personnel. In yet another embodiment even a convoy of several motor vehicles can be controlled by just one person 175.

Regardless of this, it is assumed for example that in a step 220 the motor vehicle 105 is driving under the control of an autonomous control system, which can be realized by virtue of the control device 155. In a step 225 the autonomous control system can be switched off or its switching off announced. For example a driving situation of the motor vehicle 105 may not be determinable by the autonomous control system with sufficient certainty, or a technical fault may exist on board the motor vehicle 105 which prevents the workability of the autonomous control system.

In an optional embodiment, in a step 230 the motor vehicle 105 is then driven manually by a driver. The step 230 can also be implemented without the prior steps 220 and 225.

In a step 235 the driver can relinquish control over the motor vehicle 105 or such a release can be announced. For this, in a step 240 a request is transmitted by way of the communication channel 115 for control over the motor vehicle 105 to be taken over by the remote site 110.

In a step 245 the request is received by the remote site 110. The request can then undergo the analysis of step 215. Step 215 is preferably followed by a step 250 in which a request to relinquish control over the motor vehicle 105 is transmitted via the communication channel 115.

In a step 255 this request can be received by the motor vehicle 105. Preferably, in a step 260 a confirmation of the request is generated. The confirmation can be produced automatically by the processing device 125, or a driver on board the motor vehicle 105 may be required to input the confirmation. The confirmation is then transmitted via the communication channel 115 to the remote site 110, where it is preferably received in a step 265.

The sequence described by the steps mentioned above is to be understood only as an example. In other embodiments the takeover or release of control over the motor vehicle 105 at the remote site 110 can also be initiated for other reasons, for example by a predetermined event, in particular on board the motor vehicle 105, or by an alarm. Takeover can also be initiated by the absence of a signal for longer than a predetermined period. For example, a “dead-man's-button” not operated frequently enough by the driver can be provided on board the motor vehicle 105.

In a step 270, at the remote site 110 control information for the control of the motor vehicle 105 is preferably determined and transmitted. The control information is preferably generated on the basis of the data received in step 210. It can also be generated automatically by the processing device 160 or by the person 175, who can input the corresponding signals by way of the operating element 170.

After the motor vehicle 105 has received the control information in a step 275, in a step 280 the motor vehicle 105 can be controlled on the basis of the control information received. For this, the control information received can be passed on via the interface 150 to the control device 155 directly or after further processing by the processing device 125.

### INDEXES

100 System
105 Motor vehicle
110 Remote site
115 Communication channel
120 Control unit
125 Processing device
130 Sensor
135 Communication device
140 Interface
145 Control system
150 Interface
155 Control device
160 Processing device
165 Output element
170 Operating element
175 Person
200 Method
205 Transmission of sensor data and/or driving information
210 Reception of data
215 Analysis
220 Motor vehicle driven under the control of the autonomous control system
225 Switching off of the autonomous control system
230 Manual driving
235 Release of control by the driver
240 Transmission of request
245 Reception of request
250 Transmission of request to hand over control over the motor vehicle
255 Reception of the request
260 Confirmation of the request
265 Reception of the confirmation
270 Determination and transmission of control information
275 Reception of the control information
280 Control of the motor vehicle

1-9. (canceled)

10. A control unit (120) for a motor vehicle (105), the control unit (120) comprising:
a sensor (130) for scanning an environment of the motor vehicle (105);
a communication device (135) for transmitting sensor data and for receiving control data by way of a communication channel (115); and
a processing device (125) for controlling the motor vehicle (105) on a basis of the control data received.

11. The control unit (120) according to claim 10, wherein the communication device (135) is designed to establish the communication channel (115) in at least one of a coded and an authenticated manner.

12. The control unit (120) according to claim 10, further comprising an interface (140) to another control system (145) on board the motor vehicle (105), in order to check driving information of the motor vehicle (105), the communication device (135) is designed to also transmit the driving information.

13. A method (200) for a motor vehicle (105), the method (200) comprising:
establishing (205, 210) a communication channel (115) between the motor vehicle (105) and a site (110) located outside the vehicle;
transmitting (205, 210) at least one of driving information and sensor data collected by scanning an environment of the motor vehicle (105), via the communication channel (115), to the remote site (110);
receiving, by the motor vehicle (105), a request to relinquish control over the motor vehicle (105);
receiving (275) control information by the motor vehicle (105); and
controlling (280) the motor vehicle (105) on a basis of the received control information.

14. The method (200) according to claim 13, further comprising transmitting a request (240) to assume control over the motor vehicle (105) to the site (110).

15. The method according to claim 14, further comprising transmitting the request (240) to assume control after determining (225) that an autonomous control system of the motor vehicle (105) has relinquished control.

16. The method according to claim 15, further comprising transmitting the request (240) to assume control after additionally determining (235) that a driver on board the motor vehicle (105) has not assumed control.

17. A computer program product with program code means for carrying out a method according to claim 13, when the computer program product is run on a processing device (125, 160) or stored on a computer-readable data carrier.

18. A monitoring site (110) comprising:
a communication device (135) for establishing communication channels (115) with a plurality of motor vehicles (105) such that each of the communication channels (115) is designed to receive at least one of sensor data and driving information from a motor vehicle (105) and to transmit control data to the motor vehicle (105);
an output element (165) for the output of the sensor data; and
an operating element (170) for the input of the control data.
